(19) United States
(12) Patent Application Publication
(10) Pub. No.: US 2017/0190226 A1
(43) Pub. Date: Jul. 6, 2017

(54) Tire Accessories Identifying Device and Method

(71) Applicant: Wegmann automotive GmbH & Co. KG, Veitshochheim (DE)

(72) Inventor: Gregory PARKER, Nolensville, TN (US)

(21) Appl. No.: 15/467,275

(22) Filed: Mar. 23, 2017

Related U.S. Application Data
(63) Continuation of application No. PCT/US2015/058350, filed on Oct. 30, 2015.
(60) Provisional application No. 62/073,621, filed on Oct. 31, 2014.

(51) Int. Cl. B60C 23/04; G06K 9/18; H04L 29/06; G06K 7/14; G06F 17/30

(52) U.S. Cl. CPC B60C 23/0479; G06K 7/1413; G06K 7/1417; G06F 17/30864; H04L 63/0428; G06K 9/18

(57) ABSTRACT

A computer system, a storage medium containing a computer program and a method are provided for identifying, selecting and ordering tire accessories, wheel balancing weights, tire pressure monitoring systems or service kits thereof specific to a car. A picture is taken of a vehicle's vehicle identification number (VIN) or the corresponding bar code. From the picture the VIN number is extracted by image processing. A database lookup is performed using the VIN code and selecting tire accessories, wheel balancing weights, tire pressure monitoring systems or service kits thereof suitable for the vehicle. In a further step, an order may be placed based on the selected parts.

### PRIORITY CLAIM

This application is a continuation of pending International Application No. PCT/US2015/058350 filed on Oct. 30, 2015, which designates the United States and claims priority from U.S. Application No. 62/073,621 filed on Oct. 31, 2014, each of which is incorporated herein by reference in its entirety.

### BACKGROUND OF THE INVENTION

1. Field of the Invention

The invention relates to a computer system, a storage medium containing a computer program and a method for identifying, selecting and ordering tire accessories, wheel balancing weights, tire pressure monitoring systems or service kits thereof specific to a car.

2. Description of Relevant Art

A mobile device for reading a QR code is disclosed in U.S. Pat. No. 8,884,811 B1. The QR code is read and compared to a stored QR code. If both codes match a door can be unlocked.

### SUMMARY OF THE INVENTION

The embodiments are based on the object of providing a device and a method for delivery of information about tire accessories like wheel balancing weights, tire pressure monitoring systems or service kits thereof specific to a car. The device and the method should be easily useable for unskilled persons without a specific training.

In an embodiment computer system, a storage medium containing a computer program and a method are provided for identifying, selecting and ordering tire accessories, wheel balancing weights, tire pressure monitoring systems or service kits thereof specific to a car. The computer system comprises a mobile device which may be a cell phone, a handheld computer, a laptop or any similar portable device, which is portable. The computer system further comprises a database server having a database and a communication network for communication of the mobile device with a database server.

The mobile device includes at least an image sensor for generating image data. The image sensor preferably has a lens for receiving light and focussing the light on the image sensor. The image sensor generates image data of a digital representation of a bar code or QR code or a number on a vehicle or car. Such a bar code or number preferably depicts a unique identifier of the vehicle, which may be a Vehicle Identification Number (VIN). Such a VIN may comprise letters and digits. The image data are stored in an image buffer memory for further processing. This is preferably done by a microprocessor, which extracts at least one bar code or QR code or a plurality of alphanumerical characters and calculates a VIN thereof. In an alternate embodiment, the VIN may be entered by a user for example by a keyboard or by a voice entering function. For communication, the VIN may be encoded and/or encrypted. Encoding may be done using any BCD, ANSI or ASCII or any suitable code. There may be a further 4B5B or 8B10B encoding for the transport. A means for generating first frames of data places the VIN into first frames of data for transport over a network. These frames are then transferred to a radio communication transmitter for transmitting the first frames of data to the communication network.

The communication network comprises a radio network receiver for receiving said first frames of data from the radio communication transmitter. These received frames are further transmitted via a wired section of the communication network to a database server.

The database server is connected to the wired section of the communication network for receiving said first frames of data. It is further decoding and/or decrypting said VIN. The database server has or is at least connected to a database comprising a plurality of datasets providing a relationship between at least one VIN and at least one tire accessory and/or wheel balancing weight and/or tire pressure monitoring system and/or other car accessory or spare part. The database is configured for receiving a database query based on said VIN and producing said result containing information about available tire accessories, wheel balancing weights, tire pressure monitoring systems or service kits thereof or other car accessory or spare part. The database server is further configured for generating second frames of data containing at least parts of the result preferably in an encoded and/or encrypted form and transmitting said second frames of data to the wired section of the communication network. The database server may comprise a plurality of computers, processors or servers. There may be one server hosting the database engine, whereas the database queries and the communication may be handled by a second server. The database may also comprise a plurality of partial databases, which may be hosted on different servers.

For transferring the second frames to the mobile device, the communication network comprises a radio network transmitter for receiving second frames of data from the wired section of the communication network and forwarding said second frames of data to said radio communication receiver of the mobile device.

The mobile device further comprises a radio communication receiver for receiving second frames of data transmitted by said radio network transmitter. The mobile device further comprises means for decoding and/or decrypting the result and means for outputting information based on at least parts of the result in visual or audio form. Such audio output means may be a speaker or an audio codec connected via a digital/analog converter and an amplifier to a speaker. The visual output means may comprise a display. The information output may comprise the whole result, parts of the result or further information based on the result. Such further information may be an encoded, decoded or translated result.

In a further embodiment, the mobile device provides a memory for storing a plurality of VINs and a plurality of results.

It is further preferred, if the mobile device provides a memory for collecting ordering information for tire accessories, wheel balancing weights, tire pressure monitoring systems or service kits thereof. Such ordering information may contain at least a quantity and an order number or model number.

In a further embodiment a method, executed by a computer system, for providing information about tire accessories, wheel balancing weights, tire pressure monitoring systems or service kits thereof specific to a car comprises the steps: taking a picture of a bar code or a number on a vehicle or car by means of a camera, extracting a unique identifier of the vehicle, which may be a Vehicle Identification Number (VIN), forwarding the VIN via a communication network to a database server, receiving a result containing information about available tire accessories, wheel balancing weights, tire pressure monitoring systems or other car accessories or spare parts, transferring the result over the communication network and providing an output at the mobile device based on the result.

The method may further comprise at least one of the following steps: generating image data of a bar code or a number on a vehicle by an image sensor included in a mobile device, storing said image data in an image buffer memory, extracting at least one bar code or a plurality of alphanumerical characters and calculating a Vehicle Identification Number (VIN) by means of a microprocessor, generating first frames of data containing said VIN in an encoded and/or encrypted form, transmitting the first frames of data by a radio communication transmitter, receiving said first frames of data from the radio communication transmitter by a radio network receiver of a communication network, forwarding the first frames of data via a wired section of the communication network, receiving said first frames of data by a database server connected to the communication network, decoding and/or decrypting said VIN if the data in the frames were encoded/encrypted, sending a database query based on said VIN to a database server having or being connected to a database comprising a plurality of datasets providing a relationship between at least one VIN and at least one tire accessory and/or wheel balancing weight and/or tire pressure monitoring system, the database server producing a result containing information about available tire accessories, wheel balancing weights, tire pressure monitoring systems or service kits thereof, generating the second frames of data containing at least parts of the result, encoding and/or encrypting of said result, transmitting said second frames of data to the wired section of the communication network, receiving said second frames of data from the wired section of the communication network and forwarding said second frames of data to a radio network transmitter of the communication network, receiving said second frames of data by a radio communication receiver in the mobile device, decoding and/or decrypting a result from said second frames; outputting of information based on at least parts of the result in visual or audio form.

In another embodiment, a computer program on a storage medium or on a mobile device may be provided for performing at least part of the functions of the mobile device described above.

In a further embodiment, there is a software or computer program on the mobile device or on a memory, herein called app. The app is for providing a user interface for the system and the method disclosed herein. The app may allow users, most specifically tire dealer technicians, tire store managers, distribution sales managers, etc., to check wheel balance weight application fitments, conduct quicker inventory checks of store stock and submit reorder information via email to their supplier contact, as well as view basic wheel weight related information like lead legislation updates, new product information, training videos, etc. The app may speed up the process of finding correct application fitments, increase installation accuracy and decrease errors, decrease the distribution of printed application guides. It further may speed up the process for in-store inventory checks and help to increase order accuracy.

Preferably, the app has at least a fitment search function. It may allow users the to find tire accessories, wheel balancing weights, tire pressure monitoring systems or service kits thereof either by generating image data of a VIN tag at a car, by manually entering a VIN or by selecting make, model, and year of a car.

The app may further have a virtual order pad, which may provide access a memory in the mobile device for collecting and storing ordering information. Basically, the virtual order pad is a means of sending organized emails with product data to a supplier or dealer. Ordering information may be collected based on previous results of VIN queries, by manually entering any order number or part number or by scanning bar codes of items or boxes containing items. The quantities of the items may be manually edited. The contents of the virtual order pad or parts thereof may be used to generate an e-mail by the microprocessor which may further be supplemented by adding user address and/or billing information. There may be an attachment to the mail including the ordering information as a spreadsheet like EXCEL, a database file or a text file. This file simplifies the import of the ordering information at the receiver of the e-mail. It is further preferred, if an order history is stored in memory, which may at a later time be retrieved by the user.

In general. the embodiments disclosed herein may be used for any vehicle. Furthermore, they may be used for identifying and/or selecting and/or ordering any accessory or spare part.

### BRIEF DESCRIPTION OF THE DRAWINGS

In the following, the invention will be described by way of example, without limitation of the general inventive concept, on examples of embodiment and with reference to the drawings.

FIG. 1 shows a preferred embodiment.

FIG. 2 shows an exemplary data frame which may be used for transferring information over the network.

FIG. 3 shows a VIN tag or VIN plate which may be used at vehicles or cars for identification purposes.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

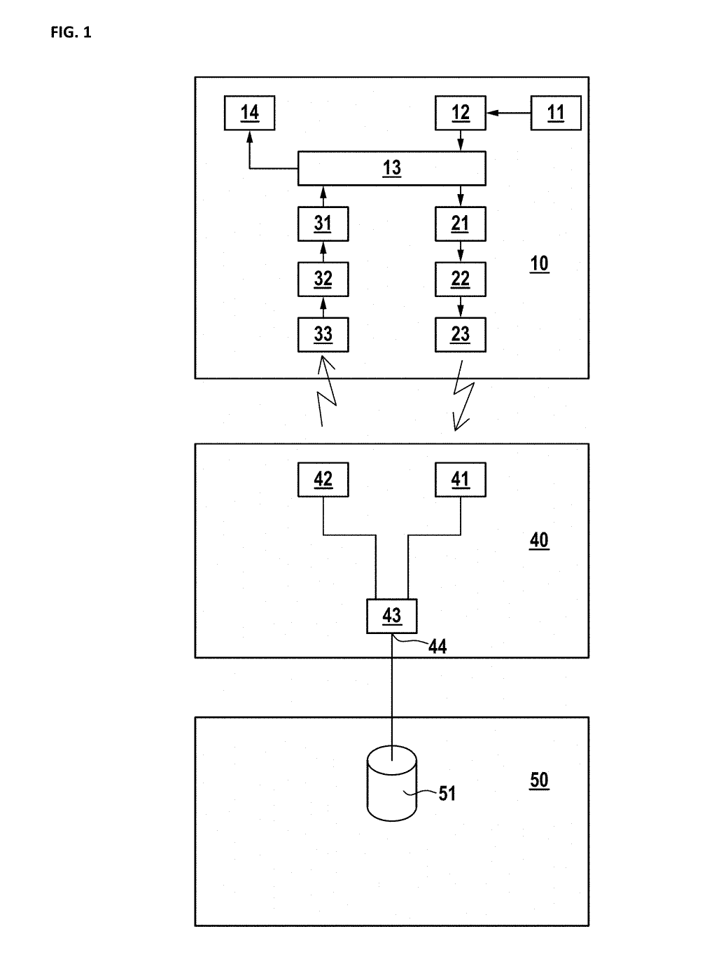

In FIG. 1, a preferred embodiment of the invention is shown. A system for providing information about tire accessories, wheel balancing weights, tire pressure monitoring systems or service kits thereof specifically for a car comprises at least a mobile device 10, a communication network 40, and a database server 50. The mobile device 10 preferably comprises an image sensor 11 and an image buffer memory 12. The image sensor 11 is for generating image data of a bar code, a QR code or a number on a vehicle. The image data is stored in an image buffer memory 12 for further processing by a microprocessor 13. The microprocessor is extracting at least one bar code or a plurality of alphanumerical characters from the image data of the buffer memory, and calculating therefrom a Vehicle Identification Number (VIN), which will be shown further below. There is at least one means 21 for assembling or generating first frames of data. Such frames of data are required for transmission of the VIN over a network. There may be further means 22 for encoding and/or encrypting of the data. It is preferred to encode the already assembled data frames or at least parts thereof. A typically suitable encoding may be 4B/5B encoding. It may also be possible to encode the VIN before assembling a frame. Such an encoding may for example be a typical character encoding as ASCII or ANSII. There may also be some encryption of the VIN before and/or after assembly into the frames. The steps of encoding/encrypting may be combined or may be performed as separate steps in either sequence which may further be performed before and/or after assembly of the frames.

The frames of data are then coupled to a radio communication transmitter 23 which generates radio signals (RF signals) for wireless transmission of the data. The radio communication transmitter 23 may comprise an RF oscillator, a modulator, an amplifier, filters, and an antenna.

The mobile device further comprises a radio communication receiver 33 for receiving wireless frames of data. The radio communication receiver may comprise an antenna, selective filters, an oscillator, a mixer, and a demodulator. The data received by the radio communication receiver 33 is forwarded to means for decoding and/or decrypting 32 of the data, and further to means for disassembly of second frames of data 31. The steps of decoding and/or decrypting are only required if the received signals are encoded and/or encrypted. The means for decoding and decrypting 32 may be before and/or after the means for disassembly of second frames or data.

The disassembled frames of data contain results transmitted from the data base which are forwarded to the microprocessor 13 for further processing. Further processing may comprise building an order list, building a local data base, or simply providing information to a user which may be any output means 14 like a visual display or an audio output which may further be done via an audio codec, a digital/analog-converter, and an amplifier for analog audio signals.

The communication network 40 comprises at least one radio network receiver 41 for receiving signals from the radio communication transmitter 23. It further comprises a radio network transmitter 42 for transmitting signals to the radio communication receiver 33 enabling a wireless communication between the mobile device 10 and the communication network 40. Although such a wireless communication is preferred, there may be wired communication, therefore omitting the radio communication transmitters and receivers and the radio network transmitters and receivers. The radio network receiver 41 and the radio network transmitter 42 are connected to a wired communication network port 43 which interfaces to a wired section 44 of the communication network.

The database server 50 is connected via the wired section 44 of the communication network and provides at least one database 51 having a plurality of datasets.

The frames of data containing a VIN as generated by the microprocessor 13 are transferred via the wireless connection from the mobile device 10 to the communication network 40, and further via the wired communication network port 43 over the wired section 44 of the communication network to the database server. The database server performs a query at the database for selecting tire accessories, wheel balancing weights, tire pressure monitoring systems, or any other vehicle accessories or spare parts related to the VIN. Generally, the VIN may be any unique identifier of a vehicle. The result of the query is returned to the mobile device 10 via the wired section of the communication network 44, the wired communication network port 43, and the wireless data connection delivering the result of the query to the microprocessor 13, for further processing.

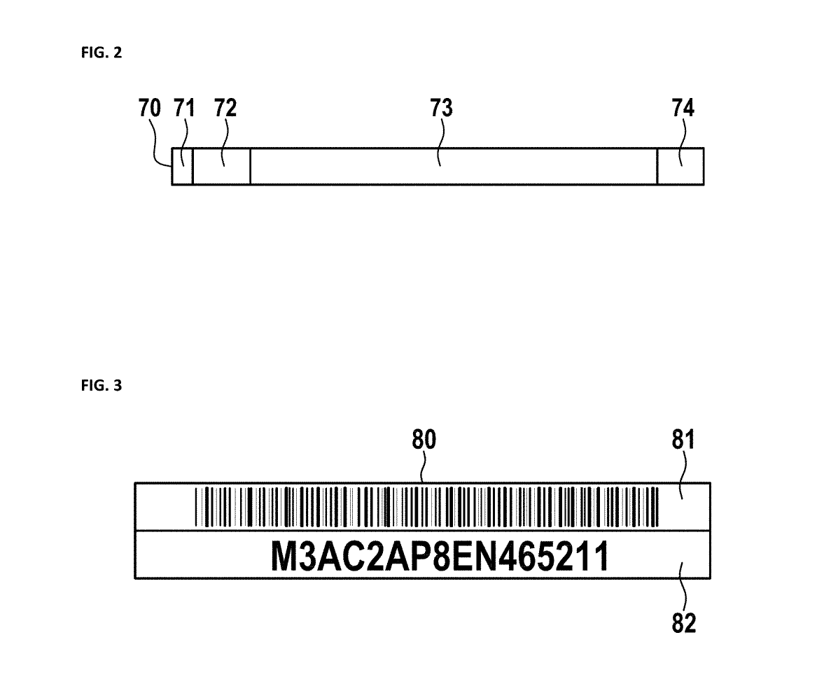

In FIG. 2, an exemplary data frame which may be used for transferring information over the network is shown. A frame of data 70 may comprise sync bits 71 followed by header bits 72, further followed by a payload section having payload bits 73, and checksum bits 74. The sync bits are for synchronizing and identifying a frame of data. The header bits comprise information about the type of frame and may further comprise routing information, like a receiver address to which the network frame has to be transferred. The payload section may contain a VIN which is communicated from microprocessor 13 to database 51 or it may contain a result of a query which is submitted by the database 51 and returned to microprocessor 13. It is preferred, if a frame of data has a checksum 74, which may be used for error detection and/or error correction.

In FIG. 3, a VIN tag or VIN plate which may be used at vehicles or cars for identification purposes is shown. The Vehicle Identification Number (VIN) tag 80 preferably comprises a barcode 81 and an alphanumerical representation also called the number 82. Both represent the VIN (Vehicle Identification Number). The Vehicle Identification Number as used in this document is a general alphanumerical representation giving a unique identifier of a car. Generally, it may comprise of any combinations of numbers and digits.

It will be appreciated to those skilled in the art having the benefit of this disclosure that this invention is believed to provide a computer system, a storage medium containing a computer program and a method for identifying, selecting and ordering tire accessories, wheel balancing weights, tire pressure monitoring systems or service kits thereof specific to a car. Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claim.

### LIST OF REFERENCE NUMERALS

10 mobile device
11 image sensor
12 image buffer memory
13 microprocessor
14 output means
21 means for assembly of first frames of data
22 means for encoding and/or encrypting
23 radio communication transmitter
31 means for disassembly of second frames of data
32 means for decoding and/or decrypting
33 radio communication receiver
40 communication network
41 radio network receiver
42 radio network transmitter
43 wired communication network port
44 wired section of communication network
50 database server
51 database
70 frame of data
71 sync bits
72 header bits
73 payload bits
74 checksum bits
80 Vehicle Identification Number (VIN) tag
81 bar code
82 number

1. System for providing information about tire accessories, wheel balancing weights, tire pressure monitoring systems or service kits thereof specific to a car, comprising:
a mobile device including an image sensor for generating image data of a bar code or a number on a vehicle, an image buffer memory for storing the image data, a microprocessor for extracting at least one bar code or QR code or a plurality of alphanumerical characters and calculating a Vehicle Ident Number (VIN), means for generating first frames of data containing said VIN in an encoded and/or encrypted form and a radio communication transmitter for transmitting the first frames of data, the mobile device further comprises a radio communication receiver for receiving second frames of data, means for decoding and/or decrypting a result and means for outputting of information based on at least parts of the result in visual or audio form;
a communication network comprising a radio network receiver for receiving said first frames of data from the radio communication transmitter, and forwarding the first frames of data via a wired section of the communication network, further comprising a radio network transmitter for receiving second frames of data from the wired section of the communication network and forwarding said second frames of data to said radio communication receiver;
a database server connected to the communication network for receiving said first frames of data and decoding and/or decrypting said VIN, the database server has or is connected to a database comprising a plurality of datasets providing a relationship between at least one VIN and at least one tire accessory and/or wheel balancing weight and/or tire pressure monitoring system, the database being configured for receiving a database query based on said VIN and producing said result containing information about available tire accessories, wheel balancing weights, tire pressure monitoring systems or service kits thereof and for generating the second frames of data containing at least parts of the result in an encoded and/or encrypted form and transmitting said second frames of data to the communication network.

2. Method for providing information by a computer system about tire accessories, wheel balancing weights, tire pressure monitoring systems or service kits thereof specific to a car, comprising:
generating image data of a bar code or QR code or a number on a vehicle by an image sensor included in a mobile device,
storing said image data in an image buffer memory,
extracting at least one bar code or QR code or a plurality of alphanumerical characters and calculating a Vehicle Identification Number (VIN) by means of a microprocessor,
generating first frames of data containing said VIN in an encoded and/or encrypted form,
transmitting the first frames of data by a radio communication transmitter,
receiving said first frames of data from the radio communication transmitter by a radio network receiver of a communication network,
forwarding the first frames of data via a wired section of the communication network,
receiving said first frames of data by a database server connected to the communication network,
decoding and/or decrypting said VIN,
sending a database query based on said VIN to a database server having or being connected to a database comprising a plurality of datasets providing a relationship between at least one VIN and at least one tire accessory and/or wheel balancing weight and/or tire pressure monitoring system,
the database server producing a result containing information about available tire accessories, wheel balancing weights, tire pressure monitoring systems or service kits thereof,
generating the second frames of data containing at least parts of the result,
encoding and/or encrypting of said result,
transmitting said second frames of data to the wired section of the communication network,
receiving said second frames of data from the wired section of the communication network and forwarding said second frames of data to a radio network transmitter of the communication network,
receiving said second frames of data by a radio communication receiver in the mobile device,
decoding and/or decrypting a result from said second frames;
outputting of information based on at least parts of the result in visual or audio form.

3. System according to claim 1, wherein the mobile device provides a memory for storing a plurality of VINs and a plurality of results.

4. System according to claim 1, wherein the mobile device provides a memory for collecting ordering information for tire accessories, wheel balancing weights, tire pressure monitoring systems or service kits thereof.
